(19) United States
(12) Patent Application Publication
(10) Pub. No.: US 2023/0010093 A1
(43) Pub. Date: Jan. 12, 2023

(54) VEHICLE AND BUILDING ROOF DEICING SYSTEMS

(71) Applicant: Creative De-Icing Solutions, Inc., Cheshire, CT (US)

(72) Inventors: Tyrone W.E. Perez, Cheshire, CT (US); Geralyn Perez, Northford, CT (US)

(73) Assignee: Creative De-Icing Solutions, Inc., Cheshire, CT (US)

(21) Appl. No.: 17/861,500

(22) Filed: Jul. 11, 2022

Related U.S. Application Data
(60) Provisional application No. 63/220,705, filed on Jul. 12, 2021.

(51) Int. Cl. B60S 1/66

(52) U.S. Cl. CPC B60S 1/66

(57) ABSTRACT

A deicer system for distributing deicer solution along a structure. The deicer system includes a deicing solution reservoir that contains the deicer solution, a pump, and one or more emitters. The pump is in fluid communication with the deicer solution reservoir and the pump is configured to distribute the deicer solution. The one or more emitters are in fluid communication with the deicer solution reservoir and the pump. The one or more emitters are positioned in a housing that is integrally connected to the structure. The one or more emitters are configured to dispense the deicer solution along the structure.

### CROSS REFERENCE TO RELATED APPLICATION

This application claims priority to commonly owned and co-pending U.S. Provisional Patent Application Ser. No. 63/220,705, filed on Jul. 12, 2021, the entirety of which is incorporated herein by reference.

### TECHNICAL FIELD

The present disclosure relates generally to deicing. More particularly, the present disclosure relates to systems for preventing or limiting ice and ice dam formation along and around roof structures.

### BACKGROUND

Residential vehicles and commercial trailer truck vehicles are often on the open road or parked outdoors during snow and ice storms, resulting in the roofs of such vehicles becoming loaded with ice and snow. The increase load of ice and snow decrease the fuel economy of the vehicles and poses a safety hazard during transit as the ice and snow may dislodge and cause traffic accidents involving following vehicles.

An ice dam is a ridge of ice that forms at the edge of a building's roof and prevents melting snow from draining off the roof. The ice dam backs up water that can leak into the building and damage the interior walls, ceilings, floors, insulation, etc.

Thus, there is a need for improved deicing systems that overcome the foregoing problems.

### SUMMARY

According to aspects illustrated herein, there is provided a deicer system for distributing deicer solution along a structure. The deicer system includes a deicing solution reservoir that contains the deicer solution, a pump, and one or more emitters. The pump is in fluid communication with the deicer solution reservoir and the pump is configured to distribute the deicer solution. The one or more emitters are in fluid communication with the deicer solution reservoir and the pump. The one or more emitters are positioned in a housing that is integrally connected to the structure. The one or more emitters are configured to dispense the deicer solution along the structure.

In one embodiment, the structure is a vehicle and the housing is a rack that is integrally connected to a roof of the vehicle. The one or more emitters are configured to dispense the deicer solution over at least a portion of the roof.

In one embodiment, the structure is a vehicle and the housing is integrally connected to a side of the vehicle adjacent a peripheral edge of a roof of the vehicle. The one or more emitters are configured to dispense the deicer solution over at least a portion of the roof.

In one embodiment, the one or more emitters are configured to extend our from one or more openings in the housing over the roof of the vehicle when in a dispensing state, and to retract into the housing through the one or more openings when in a storage state.

In one embodiment, an uppermost portion of the housing is substantially flush with the roof of the vehicle when the at least one emitter is in the storage state.

In one embodiment, the structure is a building and the housing is a gutter system that is integrally connected to one or more sides of the building and one or more peripheral edges of a roof of the building. The one or more emitters are configured to dispense the deicer solution within the gutter system and over at least a portion of the roof.

In one embodiment, the one or more emitters are spray emitters.

In one embodiment, the deicer solution is formed of a biodegradable liquid that is non-corrosive to metal materials.

Any of the foregoing embodiments may be combined.

### BRIEF DESCRIPTION OF THE DRAWING

Referring now to the Figures, which are exemplary embodiments, and wherein the like elements are numbered alike:

FIG. 1 is an isometric view of a deicer system according to an embodiment of the present invention;

FIGS. 2A-2D are a side elevation view, a top plan view, a front elevation view, and a rear elevation view, respectively, of a deicer system according to an embodiment of the present invention;

FIG. 3 is an isometric view of a deicer system according to an embodiment of the present invention; and

FIG. 4 is an enlarged view of Detail 4 of FIG. 3, showing a partial cross section of the deicer system taken along section line G-G.

### DETAILED DESCRIPTION

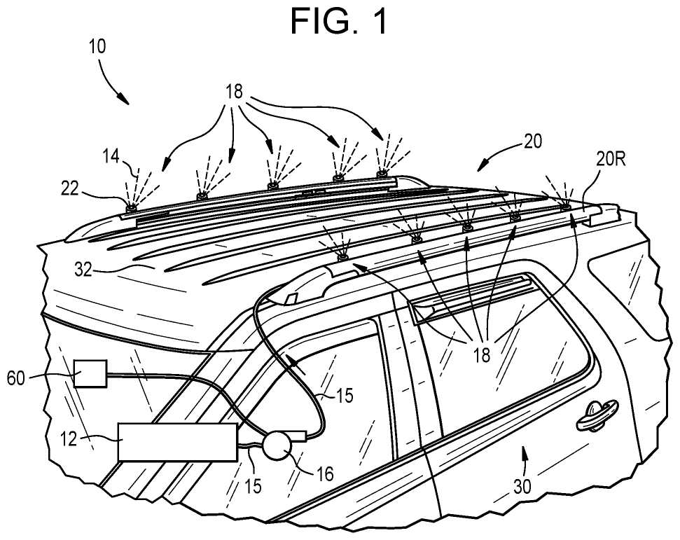

As shown in FIG. 1, a deicer system is generally designated by the number 10. The deicer system 10 includes a deicing solution reservoir 12 that contains a deicing solution 14. The deicing solution 14 is biodegradable, environmentally friendly, and is non-corrosive of metal materials. Preferably, the deicing solution 14 is a liquid solution that does not contain corrosive salts or glycols such that the deicing solution 14 is safe for use on concrete, asphalt, brick, rubber, stone, and wood surfaces. In some embodiments, the deicing solution 14 has a freezing point of about −72° F. (about −58° C.). A pump 16 is in fluid communication with the deicing solution reservoir 12 via tubing 15 and is configured to pump, or distribute, the deicer solution 14. The pump 16 may be, for example, an electrical pump, a pneumatic pump, a hydraulic pump, or a mechanical pump such a belt driven pump, a gear driven pump, an axle driven pump, or a pump driven by air flow caused by a vehicle in motion, etc. One or more emitters 18 are in fluid communication with the deicer solution reservoir 12 and the pump 16 via tubing 15. The emitters 18 are configured to dispense the deicer solution 14 pumped from the deicer solution reservoir 12 onto a surface (e.g., the roof of a structure). Preferably, the emitters 18 are spray emitters (e.g., spray nozzles). In some embodiments, the emitters 18 dispense the deicer solution 14 at a pressure in the range of about 10 psi to about 70 psi. In some embodiments, the emitters 18 dispense the deicer solution 14 at a pressure of about 40 psi. In some embodiments, the emitters 18 dispense the deicer solution 14 at a pressure of less than 40 psi. In some embodiments, the emitters 18 dispense the deicer solution 14 with an angle of deployment in the range of about 30 degrees to about 60 degrees as measured upward from a horizontal plane. In some embodiments, the emitters 18 dispense the deicer solution 14 with an angle of deployment of about 45 degrees as measured upward from the horizontal plane. In some embodiments, the emitters 18 are configured to pivot to dispense the deicer solution 14 with an angle of deployment that is variable in the range of about 30 degrees to about 60 degrees as measured upward from the horizontal plane.

In some embodiments, the emitters 18 are positioned within a housing 20 that is integrally connected to a roof of a structure. For example, as shown in FIG. 1, the emitters 18 are positioned within a rack 20R (e.g., a luggage rack) that is integrally connected to the roof 32 of a vehicle 30, (e.g., an automobile, SUV, a truck, a tractor trailer truck, an off road vehicle, or other motor vehicle). The emitters 18 are configured to spray the deicer solution 14 out through openings 22 in the rack 20R onto the roof 32 of the vehicle 30 to prevent ice from forming thereon while also melting snow accumulations. In some embodiments, the emitters 18 are movable between a dispensing state and a storage state. When in the dispensing state, the emitters 18 are configured to extend out, or pop up, from the openings 22 to spray the deicer solution 14 over the roof 32. When in the storage state, the emitters 18 are configured to retract through the openings 22 for storage within the rack 20R when not in use. The emitters 18 extend/retract through the openings 22 via, for example, resilient members (e.g., springs), biasing units (e.g., mechanically, electronically, or hydraulically driven telescoping or rotating members), fluid pressure within the tubing 15. In some embodiments, the extension/retraction of the emitters 18 is separately controlled, either manually or automatically, by a controller 60. In some embodiments, the extension/retraction of the emitters 18 occurs in direct response to the pressure flow of the deicer solution 14 within the tubing 15. In some embodiments, the emitters 18 are positioned within two racks 20R on opposing edges of the roof 32 to provide better roof coverage of the deicer solution 14. The deicer solution reservoir 12 and the pump 16 may be mounted, for example, under the hood of the vehicle or underneath the vehicle. The tubing 15 may be run throughout the frame of the vehicle 30 and into the rack 20R such that the deicer system 10 is not readily visible when not in use.

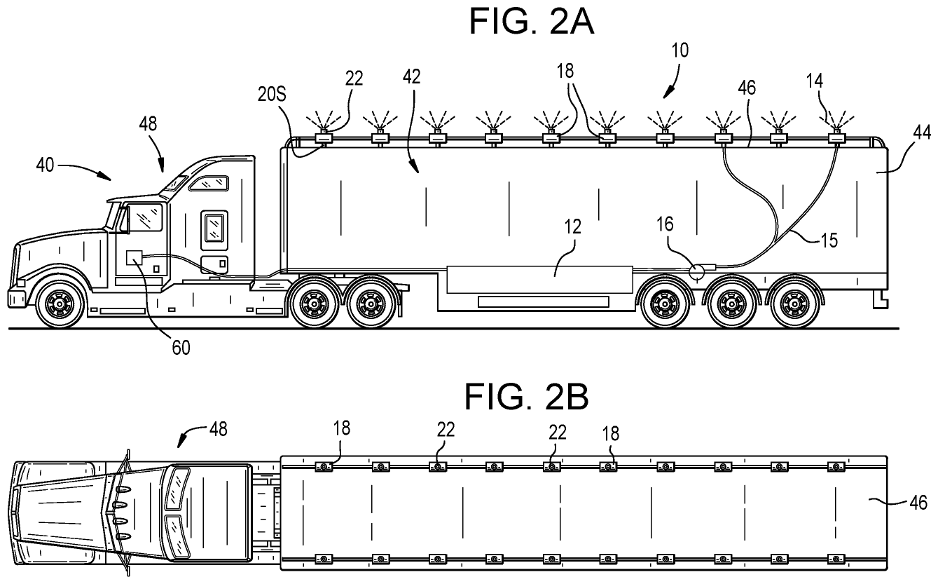

In some embodiments, the emitters 18 are positioned within a housing 20 that is integrally connected to a side of a structure. For example, as shown in FIGS. 2A-2D, the emitters 18 are positioned within a side mount 20S that is integrally connected to a side 44 of a trailer 42 adjacent a peripheral edge of the roof 46 of the trailer 42. The trailer 42 is attached to a truck 40, such as a semi-tractor-trailer truck (i.e. an 18-wheeler truck). The emitters 18 are preferably movable between a dispensing state and a storage state. When in the dispensing state, the emitters 18 are configured to extend out from openings 22 in the side mount 20S to spray the deicer solution 14 onto the roof 46 to prevent ice from forming thereon while also melting snow accumulations. When in the storage state, the emitters 18 are configured to retract through the openings 22 into the side mount 20S such that an uppermost portion of the side mount is substantially flush with the roof 46 when not in use. Thus, the truck 40 can travel under a snow scraper at a Truck Stop without damaging the deicing system 10. The emitters 18 extend/retract through the openings 22 via, for example, resilient members (e.g., springs), biasing units (e.g., mechanically, electronically, or hydraulically driven telescoping or rotating members), fluid pressure within the tubing 15. In some embodiments, the extension/retraction of the emitters 18 is separately controlled, either manually or automatically, by a controller 60. In some embodiments, the extension/retraction of the emitters 18 occurs in direct response to the pressure flow of the deicer solution 14 within the tubing 15. In some embodiments, the emitters 18 are positioned within two side mounts 20S on opposing sides 44 of the trailer 42 to provide better roof coverage of the deicer solution 14. The deicer solution reservoir 12 and the pump 16 may be mounted, for example, behind the cab 48 of the truck 40 or underneath the trailer 42. The tubing 15 may be run throughout the frame of the trailer 42 and into the side mount 20S such that the deicer system 10 is not readily visible when not in use.

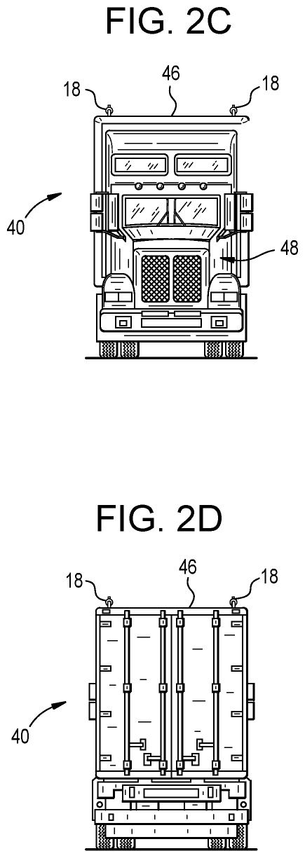

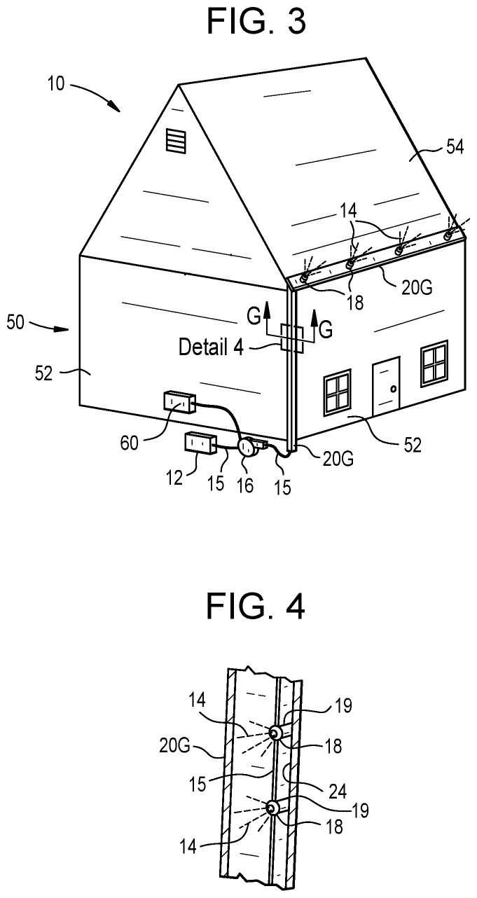

In some embodiments, the emitters 18 are positioned within a housing 20 that is integrally connected to multiple surfaces of a structure. For example, as shown in FIG. 3, the emitters 18 are positioned within a gutter system 20G that is integrally connected to one or more sides 52 and one or more peripheral edges of a roof 54 of a building 50. The emitters 18 are mounted inside the gutter system 20G via mounting members 19 (e.g., brackets, fasteners, etc.) that are attachable to an interior wall 24 of the gutter system 20G, as shown in FIG. 4. As shown in FIG. 3, the emitters 18 are configured to spray the deicer solution 14 within the gutter system 20G and onto the roof 54 to prevent ice from forming and ice damming from occurring. As shown in FIG. 4, the emitters 18 are configured to spray the deicer solution 14 along the interior walls 24 of downspout portions of the gutter system 20G to prevent ice from forming within the gutter system 20G. The deicer solution reservoir 12 and the pump 16 may be installed, for example, in the basement of the building, on or under the ground adjacent the building, or in an adjacent structure, such as a garage. As shown in FIG. 4, the tubing 15 is run throughout the gutter system 20G such that the deicer system 10 is not readily visible when not in use.

In some embodiments, the deicer system 10 includes a controller 60 that is in electrical communication with the pump 16 and is positioned within the structure (e.g., the vehicle 30, the cab 48 of the truck 40, the building 50) such that a user can manually operate the deicer system 10. In some embodiments, the deicer system 10 includes one or more sensors (e.g., temperature sensor, pressure sensor, water sensor, etc.) (not shown) in electrical communication with the controller, which is configured to automatically operate the deicer system 10 when predetermined conditions are detected by the sensors.

While the present disclosure has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A deicer system for distributing deicer solution along a structure, the deicer system comprising:
a deicing solution reservoir containing the deicer solution;
a pump in fluid communication with the deicer solution reservoir, the pump is configured to distribute the deicer solution; and
at least one emitter in fluid communication with the deicer solution reservoir and the pump, the at least one emitter is positioned in a housing that is integrally connected to the structure, the at least one emitter is configured to dispense the deicer solution along the structure.

2. The deicer system of claim 1, wherein the structure is a vehicle and the housing is a rack that is integrally connected to a roof of the vehicle, the at least one emitter is configured to dispense the deicer solution over at least a portion of the roof.

3. The deicer system of claim 1, wherein the structure is a vehicle and the housing is integrally connected to a side of the vehicle adjacent a peripheral edge of a roof of the vehicle, the at least one emitter is configured to dispense the deicer solution over at least a portion of the roof.

4. The deicer system of claim 3, wherein the at least one emitter is configured to extend out from at least one opening in the housing over the roof of the vehicle when in a dispensing state, and to retract into the housing through the at least one opening when in a storage state.

5. The deicer system of claim 4, wherein an uppermost portion of the housing is substantially flush with the roof of the vehicle when the at least one emitter is in the storage state.

6. The deicer system of claim 1, wherein the structure is a building and the housing is a gutter system that is integrally connected to at least one side of the building and at least one peripheral edge of a roof of the building, the at least one emitter is configured to dispense the deicer solution within the gutter system and over at least a portion of the roof.

7. The deicer system of claim 1, wherein the at least one emitter is a spray emitter.

8. The deicer system of claim 1, wherein the deicer solution comprises a biodegradable liquid that is non-corrosive to metal materials.
